(19) United States
(12) Patent Application Publication
(10) Pub. No.: US 2024/0202555 A1
(43) Pub. Date: Jun. 20, 2024

(54) METHOD AND SYSTEM FOR PROVIDING VIRTUAL ASSISTANT IN A MEETING

(71) Applicant: JPMorgan Chase Bank, N.A., New York, NY (US)

(72) Inventors: Abhishek MITRA, Bangalore (IN); Ajay VERMA, Bangalore (IN); Apoorva JAISWAL, Kanpur (IN); Yogita RANI, Mansa (IN); Gaurav KARKAL, Bangalore (IN)

(73) Assignee: JPMorgan Chase Bank, N.A., New York, NY (US)

(21) Appl. No.: 18/109,538

(22) Filed: Feb. 14, 2023

(30) Foreign Application Priority Data
Dec. 20, 2022 (IN) 202211074004

(51) Int. Cl. G06N 5/043; G06V 40/20; G10L 17/22; G10L 25/90

(52) U.S. Cl. CPC G06N 5/043; G06V 40/20; G10L 17/22; G10L 25/90

(57) ABSTRACT

A method and system for providing a virtual assistant to participants in a meeting. The method includes receiving a set of data associated with the meeting. The set of data includes meeting details, participant details, discussion details, audio details, and video details. Next, the method includes analyzing, using a trained model, the set of data to provide the virtual assistant to the participants in the meeting. Thereafter, the method includes assisting the participants in the meeting based on the analysis of the set of data.

### CROSS-REFERENCE TO RELATED APPLICATIONS

This application claims priority benefit from Indian Application No. 202211074004, filed Dec. 20, 2022 in the Indian Patent Office, which is hereby incorporated by reference in its entirety.

### FIELD OF THE DISCLOSURE

This technology generally relates to the field of communication, and more particularly to methods and systems for providing virtual assistance to the participants of a meeting.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

It is known that in today's organizational context, most meetings are conducted online using various online meeting platforms. These platforms enable different participants to join the meeting from different geographical regions of the world which also saves the travel time of the participants and reduces the turnaround time of the project.

However, such online meeting platforms also include multiple drawbacks which affect the meeting experience of the participants. For instance, during an online meeting, most of the participants are not aware of the geographical regions and time zones of other participants of the meeting due to which the participants from other geographies are not greeted properly as per their time zones and thus, it affects the meeting experience. Also, many a time, one or more participants of the meeting faces a communication gap due to various factors such as internet issues, emergency situations. Break in communication due to such factors lead to loss of information associated with the respective discussion matters which affect the overall efficiency and outcome of the matter. Similarly, there are several examples which show the drawback of the existing online meeting platforms.

Hence, in view of these and other existing limitations/drawbacks, there arises an imperative need to provide an efficient solution to overcome the above-mentioned limitations and to provide a method and system to assist the participants of the meeting for increasing their overall experience of the online meeting.

### SUMMARY

The present disclosure, through one or more of its various aspects, embodiments, and/or specific features or sub-components, provides, inter alia, various systems, servers, devices, methods, media, programs, and platforms for providing a virtual assistant to the participants in a meeting.

According to an aspect of the present disclosure, a method for providing a virtual assistant to the participants in a meeting is disclosed. The method is implemented by at least one processor. The method includes the step of receiving, at a processor, a set of data associated with the meeting. Next, the method includes the step of analyzing, by a processor using a trained model, the set of data to provide the virtual assistant to the participants in the meeting. Thereafter, the method includes the step of assisting, by the processor, the participants in the meeting based on the analysis of the set of data.

In accordance with an exemplary embodiment, the set of data includes meeting details, participant details, discussion details, audio details, and video details.

In accordance with an exemplary embodiment, the participants in the meeting are assisted by first receiving audio data associated with a speaker that is participating in the meeting. Next, the received audio data is transcribed into raw textual data. Next, the raw textual data is processed into processed textual data. The processed textual data comprises a name of the speaker, corresponding text, a start time at which the speaker begins speaking, and an end time at which the speaker stops speaking. Next, the processed textual data is displayed via a display based on a requirement of the participants.

In accordance with an exemplary embodiment, the participants in the meeting are assisted by receiving geographic details and time zone details of the participants. Next, the geographic details and the time zone details of the participants are analyzed to determine a variation among the geographic details and the time zone details of the participants in the meeting. Next, a notification is displayed that relates to the variation among the geographic details and the time details of the participants in the meeting.

In accordance with an exemplary embodiment, the participants in the meeting are assisted by receiving audio data associated with at least one speaker that is participating in the meeting. Next, the audio data is analyzed using the trained model in real-time to detect unconscious bias words used by the at least one speaker. In an embodiment of the present disclosure, the model is trained using machine learning algorithms. In another embodiment of the present disclosure, the model is trained as per a requirement of the present invention. Next, a notification is displayed to the at least one speaker that relates to the unconscious bias words. Thereafter, a replacement of the unconscious bias words is suggested to the at least one speaker.

In accordance with an exemplary embodiment, the participants in the meeting are assisted by receiving audio data associated with the participants in the meeting. Next, the audio data is analyzed using the trained model to detect a pitch of one of the participants, text spoken by the one of the participants, and a time duration of a spoken sentence. Thereafter, a notification associated with at least one event for which the pitch of the one of the participants is higher than a predefined threshold level based on the analysis of the audio data is displayed via a display.

In accordance with an exemplary embodiment, the participants in the meeting are assisted by receiving video data associated with the participants in the meeting. Next, the video data is analyzed using the trained model to detect a gesture and an emotion of one of the participants, text spoken by the one of the participants, and a time duration of a spoken sentence. Next, a notification associated with at least one event for which the emotion of the one of the participants is identified as being an unfavorable emotion is displayed via a display.

According to another aspect of the present disclosure, a computing device configured to implement an execution of a method for providing a virtual assistant to the participants in a meeting is disclosed. The computing device includes a processor; a memory; and a communication interface coupled to each of the processor and the memory. The processor is configured to: receive a set of data associated with the meeting; analyze a set of data using a trained model to provide the virtual assistant to the participants in the meeting; and assist the participants in the meeting based on the analysis of the set of data.

In accordance with an exemplary embodiment, the set of data comprises meeting details, participant details, discussion details, audio details and video details.

In accordance with an exemplary embodiment, the processor may be configured to assist the participants by receiving audio data associated with a speaker that is participating in the meeting; transcribing the received audio data into raw textual data; processing the raw textual data into processed textual data, wherein the processed textual data comprises a name of the speaker, corresponding text, a start time at which the speaker begins speaking, and an end time at which the speaker stops speaking; and displaying the processed textual data via a display based on a requirement of the participants.

In accordance with an exemplary embodiment, the processor may be configured to assist the participants by receiving geographic details and time zone details of the participants; analyzing the geographic details and the time zone details of the participants to determine a variation among the geographic details and the time zone details of the participants in the meeting; and displaying, via a display, a notification that relates to the geographic details and the time zone details of the participants in the meeting.

In accordance with an exemplary embodiment, the processor may be configured to assist the participants by receiving audio data associated with at least one speaker that is participating in the meeting; analyzing the audio data using the trained model in real-time to detect unconscious bias words used by the at least one speaker; displaying, via a display, a notification to the at least one speaker that relates to the unconscious bias words; and suggesting a replacement of the unconscious bias words to the at least one speaker.

In accordance with an exemplary embodiment, the processor may be configured to assist the participants by receiving audio data associated with the participants in the meeting; analyzing the audio data using the trained model to detect a pitch of one of the participants, text spoken by the one of the participants, and a time duration of a spoken sentence; and displaying, via a display, a notification associated with at least one event for which the pitch of the one of the participants is higher than a predefined threshold level based on the analysis of the audio data.

In accordance with an exemplary embodiment, the processor may be configured to assist the participants by receiving video data associated with the participants in the meeting; analyzing the video data using the trained model to detect a gesture and an emotion of one of the participants, text spoken by the one of the participants, and a time duration of a spoken sentence; and displaying, via a display, a notification associated with at least one event for which the emotion of the one of the participants is identified as being an unfavorable emotion.

According to yet another aspect of the present disclosure, a non-transitory computer readable storage medium storing instructions for providing a virtual assistant to the participants in a meeting is disclosed. The instructions include executable code which, when executed by a processor, may cause the processor to: receive a set of data associated with the meeting; analyze the set of data using a trained model to provide the virtual assistant to the participants in the meeting; and assist the participants in the meeting based on the analysis of the set of data.

In accordance with an exemplary embodiment, the set of data comprises meeting details, participant details, discussion details, audio details, and video details.

In accordance with an exemplary embodiment, when executed by the processor, the executable code further causes the processor to assist the participants by: receiving audio data associated with a speaker that is participating in the meeting; transcribing the received audio data into raw textual data; processing the raw textual data into processed textual data, wherein the processed textual data comprises a name of the speaker, corresponding text, a start time at which the speaker begins speaking, and an end time at which the speaker stops speaking; and displaying, via a display, the processed textual data based on a requirement of the participants.

In accordance with an exemplary embodiment, when executed by the processor, the executable code further causes the processor to assist the participants by: receiving geographic details and time zone details of the participants; analyzing the geographic details and the time zone details of the participants to determine a variation among the geographic details and the time zone details of the participants in the meeting; and displaying, via a display, a notification that relates to the variation among the geographic details and the time zone details of the participants in the meeting.

In accordance with an exemplary embodiment, when executed by the processor, the executable code further causes the processor to assist the participants by: receiving audio data associated with at least one speaker that is participating in the meeting; analyzing the audio data using the trained model in real-time to detect unconscious bias words used by the at least one speaker; displaying, via a display, a notification to the at least one speaker that relates to the unconscious bias words; and suggesting a replacement of the unconscious bias words to the at least one speaker.

In accordance with an exemplary embodiment, when executed by the processor, the executable code further causes the processor to assist the participants by: receiving audio data associated with the participants in the meeting; analyzing the audio data using the trained model to detect a pitch of one of the participants, text spoken by the one of the participants, and a time duration of a spoken sentence; and displaying, via a display, a notification associated with at least one event for which the pitch of the one of the participants is higher than a predefined threshold level based on the analysis of the audio data.

In accordance with an exemplary embodiment, when executed by the processor, the executable code further causes the processor to assist the participants by: receiving video data associated with the participants in the meeting; analyzing the video data using the trained model to detect a gesture and an emotion of one of the participants, text spoken by the one of the participants, and a time duration of a spoken sentence; and displaying, via a display, a notification associated with at least one event for which the emotion of the one of the participants is identified as being an unfavorable emotion.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a virtual assistant to the participants in a meeting, in accordance with an exemplary embodiment of the present disclosure.

FIG. 4 illustrates an exemplary method flow diagram for providing a virtual assistant to the participants in a meeting, in accordance with an exemplary embodiment of the present disclosure.

FIG. 5 is a diagram that illustrates a process flow usable for implementing a method for providing a virtual assistant to the participants in a meeting, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the invention. It will be apparent however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

To overcome various problems associated with the online meeting platforms, the present disclosure provides a method and system for providing efficient virtual assistance to the participants in a meeting. The present disclosure assists the participants of the meeting to enhance the virtual meeting experience of the participants and to make the meeting more inclusive. The present disclosure first receives a set of data associated with the meeting. The set of data includes but is not limited to meeting details, participant details, discussion details, audio details, and video details. Next, the present disclosure analyzes the set of data to provide a virtual assistant to the participants in the meeting. Thereafter, the present disclosure assists the participants in the meeting based on the analysis of the set of data. In an example, the present disclosure assists the participants by notifying about the geographic details and time zone details of other participants so that the participants in the meeting can greet properly in the meeting as per their respective time zones. In another example, the present disclosure assists the participants in preventing the use of any unconscious bias words by the participants during meeting. In yet another example, the present disclosure assists the participants by providing a summary or report of the meeting after the call in an event that the one or more participants fail to attend the meeting or leave the meeting early. In yet another example, the present disclosure assists the participants by notifying the participants about their unfavorable emotion(s) during the meeting based on their pitch and gesture. In an example, the unfavorable emotion includes but is not limited to an aggressive emotion, an assertive emotion, and/or an anger emotion of the participants in the meeting.

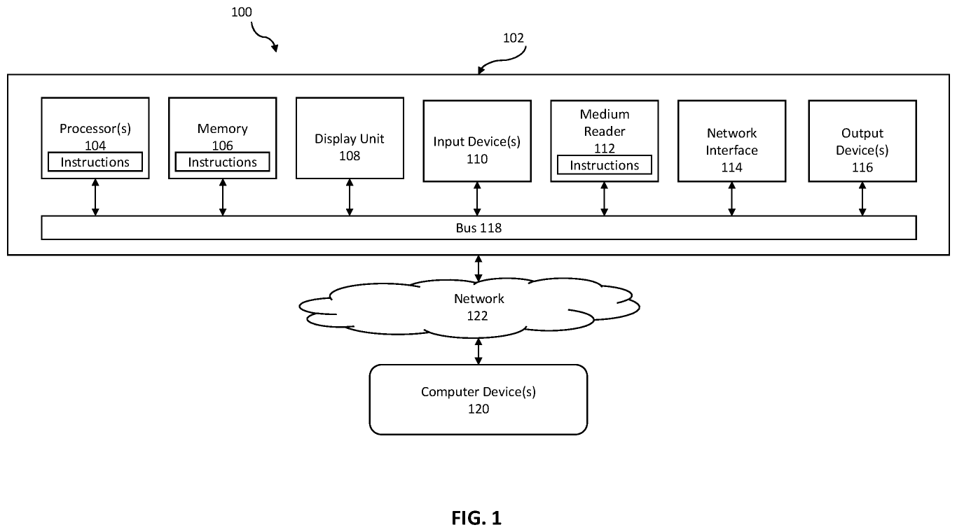

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such a cloud-based computing environment.

In a networked deployment, the computer system 102 may operate in the capacity of a server or as a client user computer in a server-client user network environment, a client user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As used herein, the term “Participant” (or “participant”) refers to a user or an individual attending the meeting virtually. In a non-limiting example, the Participant attends the meeting for discussion on any project, for entertainment, for training, for learning and the like. Further, the Participant may attend the meeting remotely from any location with internet connectivity.

As used herein, audio data refers to data received from an audio file or generated based on the speech of the participants in the meeting. In an example, audio data may be received via an input device such as a microphone of the electronic device.

As used herein, unconscious bias words refer to offensive, prejudiced, excluding, and/or hurtful words or phrases that may be used by the participants in the meeting.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present invention, the computer memory 106 may comprise any combination of memories or a single storage.

The computer system 102 may further include a Display Unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer (PC). However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a virtual assistant to the participants in a meeting.

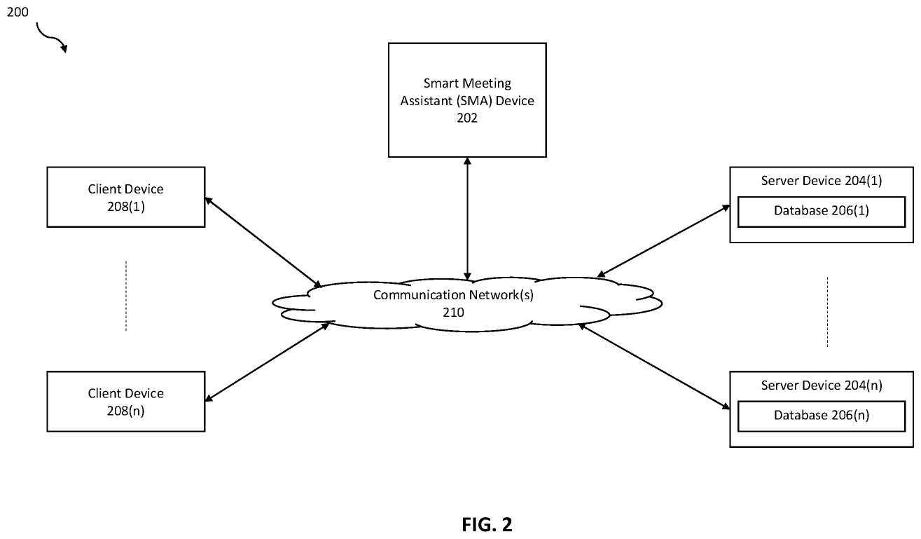

Referring to FIG. 2, a schematic of an exemplary network environment 200 for implementing a method for providing a virtual assistant to the participants in a meeting is illustrated. In an exemplary embodiment, the method is executable on any networked computer platform, such as, for example, a personal computer (PC).

The method for providing a virtual assistant to the participants in a meeting may be implemented by a Smart Meeting Assistant (SMA) device 202. The SMA device 202 may be the same or similar to the computer system 102 as described with respect to FIG. 1. The SMA device 202 may store one or more applications that can include executable instructions that, when executed by the SMA device 202, cause the SMA device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as virtual machine(s) or virtual server(s) that may be managed in a cloud-based computing environment. Also, the application(s), and even the SMA device 202 itself, may be located in virtual server(s) running in a cloud-based computing environment rather than being tied to one or more specific physical network computing devices. Also, the application(s) may be running in one or more virtual machines (VMs) executing on the SMA device 202. Additionally, in one or more embodiments of this technology, virtual machine(s) running on the SMA device 202 may be managed or supervised by a hypervisor.

In the network environment 200 of FIG. 2, the SMA device 202 is coupled to a plurality of server devices 204(1)-204(n) that hosts a plurality of databases 206(1)-206(n), and also to a plurality of client devices 208(1)-208(n) via communication network(s) 210. A communication interface of the SMA device 202, such as the network interface 114 of the computer system 102 of FIG. 1, operatively couples and communicates between the SMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SMA devices that efficiently implement a method for providing a virtual assistant to the participants in a meeting.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), Public Switched Telephone Network (PSTNs), Ethernet-based Packet Data Networks (PDNs), combinations thereof, and the like.

The SMA device 202 may be a standalone device or integrated with one or more other devices or apparatuses, such as one or more of the server devices 204(1)-204(n), for example. In one particular example, the SMA device 202 may include or be hosted by one of the server devices 204(1)-204(n), and other arrangements are also possible. Moreover, one or more of the devices of the SMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the SMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to meeting details, geographical details, participants details, audio, video details, time zones, linguistics details, software programs, and machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SMA device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SMA device 202, the server devices 204(1)-204(n), or the client devices 208(1)-208(n), for example, may be configured to operate as virtual instances on the same physical machine. In other words, one or more of the SMA device 202, the server devices 204(1)-204(n), or the client devices 208(1)-208(n) may operate on the same physical device rather than as separate devices communicating through communication network(s) 210. Additionally, there may be more or fewer SMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, Packet Data Networks (PDNs), the Internet, intranets, and combinations thereof.

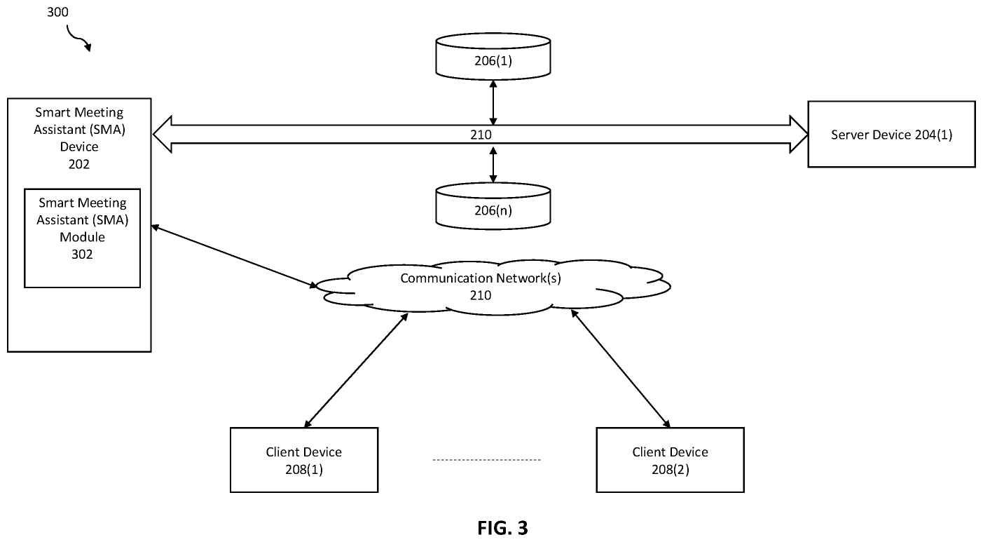

FIG. 3 illustrates an exemplary system for implementing a method for providing a virtual assistant to the participants in a meeting, in accordance with an exemplary embodiment. As illustrated in FIG. 3, according to exemplary embodiments, the system 300 may comprise an SMA device 202 including an SMA module 302 that may be connected to a server device 204(1) and one or more repository 206(1) . . . 206(n) via a communication network 210, but the disclosure is not limited thereto.

The SMA device 202 is described and shown in FIG. 3 as including a Smart Meeting Assistant module 302, although it may include other rules, policies, modules, databases, or applications, for example. As will be described below, the smart meeting assistant module 302 is configured to implement a method for providing a virtual assistant to the participants in a meeting.

An exemplary process 300 for implementing a mechanism for providing a virtual assistant to the participants in a meeting by utilizing the network environment of FIG. 2 is shown as being executed in FIG. 3. Specifically, a first client device 208(1) and a second client device 208(2) are illustrated as being in communication with SMA device 202. In this regard, the first client device 208(1) and the second client device 208(2) may be “clients” of the SMA device 202 and are described herein as such. Nevertheless, it is to be known and understood that the first client device 208(1) and/or the second client device 208(2) need not necessarily be “clients” of the SMA device 202, or any entity described in association therewith herein. Any additional or alternative relationship may exist between either or both of the first client device 208(1) and the second client device 208(2) and the SMA device 202, or no relationship may exist.

Further, SMA device 202 is illustrated as being able to access the one or more repositories 206(1) 206(n). The smart meeting assistant module 302 may be configured to access these repositories/databases for implementing a method for providing a virtual assistant to the participants in a meeting.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SMA device 202 via broadband or cellular communication. Of course, these embodiments are merely exemplary and are not limiting or exhaustive.

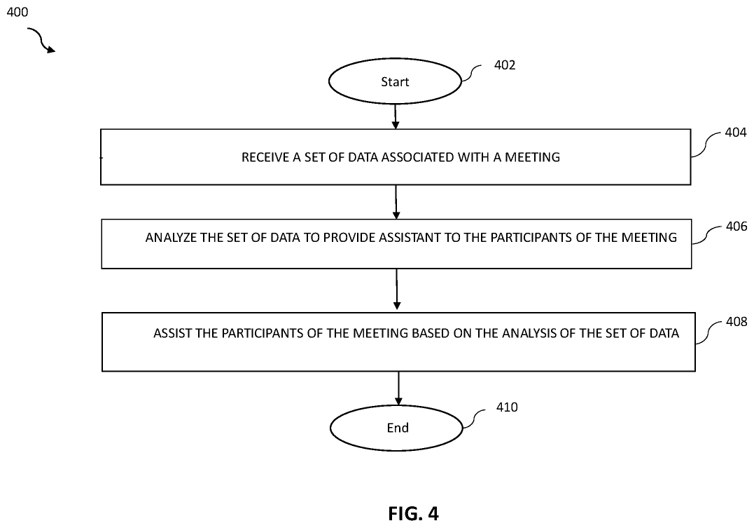

Referring to FIG. 4, an exemplary method is shown for providing a virtual assistant to participants in a meeting, in accordance with an exemplary embodiment of the present disclosure. As shown in FIG. 4, the method begins at step following a need to assist the participants in the meeting in various situations.

At step [404], the method comprises receiving, at a processor, a set of data associated with the meeting. The set of data includes but is not limited to meeting details, participant details, discussion details, audio details, and video details. The meeting details correspond to the information associated with the meeting such as meeting time, meeting place, meeting platform, meeting type and the like. The participant details correspond to the information associated with the participants such as number of participants, geographical details of the participants, current location details of the participants, time zone details of the participants and the like. The discussion details correspond to the audio discussion, video discussion, text-based discussion, documents-based discussion, and the like. In an example, the discussion details may be received in the audio format, video format, raw data format and the like for further processing. The audio details correspond to the audio received from the one or more participants in the meeting. In an example, the sentence used by Participant 1 i.e., “Hello how are you” in the meeting is considered as the audio input or audio data. The video details correspond to the information associated with video or images of the participants.

At step [406], the method comprises analyzing, by a processor using a trained model, the set of data to provide the virtual assistant to the participants of the meeting. The set of data is analyzed using a trained model to identify various parameters associated with the data. In a non-limiting embodiment of the present disclosure, the trained model corresponds to an Artificial Intelligence based model and Machine Learning based model which uses the past data to provide assistance to the participants. In an exemplary embodiment, the machine learning model may include supervised learning algorithms such as, for example, k-medoids analysis, regression analysis, decision tree analysis, random forest analysis, k-nearest neighbors' analysis, logistic regression analysis, K-fold cross-validation analysis, balanced class weight analysis, etc. In another exemplary embodiment, the trained model corresponds to the unsupervised machine learning model. Using the trained model, the processor analyzes the received data such as audio data, video data, meeting data, and/or participant data to detect a pitch of the participants, to detect an emotion of the participants, to identify the time zone variation among the participants, to identify the geographical variation between the location of the participants, to detect the use of unconscious bias words by the participants, and/or to perform a number of tasks required for providing assistance to the participants in the meeting.

At step [408], the method comprises, assisting, by the processor, the participants in the meeting based on the analysis of the set of data. The participants in the meeting are assisted in different ways using the received data. In an embodiment of the present disclosure, the participants in the meeting are assisted in real-time. In another embodiment of the present disclosure, the participants in the meeting are also assisted post meeting. In yet another embodiment of the present disclosure, the participants in the meeting are assisted before the start of the meeting depending upon the data received by the processor.

In an embodiment of the present disclosure, the participants in the meeting are assisted by first receiving, at the processor, audio data associated with one or more speakers and/or participants in the meeting. Next, the method comprises transcribing, by the processor, the received audio data into raw textual data. Next, the method comprises processing, by the processor, the raw textual data into processed textual data. The processed textual data comprises a name of the speaker, corresponding text, a start time at which the speaker begins speaking, and an end time at which the speaker stops speaking. Next, the method comprises displaying, by the processor via a display, the processed textual data associated with the meeting to one or more participants of the meeting based on one or more requirement(s) of the participants.

In an example, Participant A, Participant B, Participant C, and Participant D attend a meeting. All the participants of the meeting conduct a discussion on a project. However, due to an emergency, Participant B drops out of the Meeting at the approximate halfway point of the meeting. Implementation of the features of the present invention will help and assist Participant B by providing a summary of the call in a defined and structured format after the meeting. To prepare the summary, the processor receives the audio file and processes the audio file to convert the speech into a text format. The speech of the user is converted into the text format to form a raw output of the summary. Next, the raw output is further processed by the processor to convert the raw output into a processed or structured output. In an example, the raw output is generated in the raw form i.e., “Hi Everyone. How are you. It was a nice presentation”. The conversion of the raw output into the processed output appears as:
“05:30:08, 05:30:56, Participant_A, Hi Everyone”
“05:31:15, 05:31:50, Participant_B, How are you”
“05:32:04, 05:32:58, Participant_C, It was a nice presentation”

In another example, the present invention also allows Participant 1 to indicate, in an offline manner at the start or in advance, that Participant 1 has a hard stop at 10:30 AM so that other participants can plan their communications accordingly. Based on Participant 1's indication, the meeting assistant of the present invention can create non-interruptive cues (e.g., silent time check pop ups) for the other participants in a periodic manner. If other participants choose to continue, they can indicate the same in a non-interruptive way (e.g., a silent check box) and the meeting assistant can automatically record, transcribe and or summarize the rest of the conversation and deliver it to Participant 1.

In an embodiment of the present disclosure, the participants in the meeting are assisted by first receiving, at the processor, geographic details and time zone details of the participants. Next, the method comprises analyzing, by the processor, the geographic details and the time zone details of the participants to determine one or more variation(s) among the geographic details and the time zone details of one or more participants in the meeting. Next, the method comprises displaying, by the processor via a display, a notification that relates to the variation(s) among the geographic details and/or the time zone details of the participants who are attending the meeting. In an embodiment of the present disclosure, the notification is displayed to the participants in the meeting who are attending from different time zones so that the participants in the meeting can be greeted appropriately as per the corresponding time zones. In another embodiment of the present disclosure, the notification may be displayed to the participants in the meeting to appropriately maintain the meeting agenda, flow, and timeboxing of the meeting.

In an example, Participant 1 and Participant 2 are from Country A and Participant 3 is from Country B. There is a time variation of at least 8 hours between the time zone for Country A and the time zone for Country B. Participant 1 greeted other participants by saying “GOOD MORNING, EVERYONE” as the Participant 1 is not aware of the time zone variations of other participants. The present invention assists the participants of the meeting either before the start of the meeting or during the meeting or post meeting. In one embodiment, the present invention may notify all the participants about the variations of the time zones before the start of the meeting. In an example, the notification before the start of the meeting may include “Please be advised this meeting involves participants from different time zones”. In another embodiment, the present invention may notify the specific participants in the meeting or post meeting based on the incorrect greeting of the participant. In an example, the present invention may notify Participant 1 during meeting on using the improper greeting. The notification may include “Please be mindful of the above local time information of participants, while greeting, conducting the meeting, scheduling Q&As, etc.”

In an embodiment of the present disclosure, the participants in the meeting are assisted by first receiving, at the processor, audio data associated with the speaker(s) that are participating in the meeting. Next, the method comprises analyzing, by the processor using a trained model, the audio data in real-time to detect unconscious bias words used by at least one speaker. Next, the method comprises displaying, by the processor via a display, the notification to the at least one speaker that relates to the use of the unconscious bias words in the meeting, in order to attempt to prevent such use. Thereafter, the method further comprises suggesting, by the processor, a replacement of the unconscious bias words to the at least one speaker. In an embodiment of the present disclosure, the processor is further configured to identify the incomplete detected unconscious bias words used in the sentences/paragraphs by using a Subject Matter Expert's (SME) curated dictionary. The SME curated dictionary facilitates the identification and detection of unconscious bias words used by the speaker(s) in the meeting in a more reliable manner. The processor is also configured to handle a different sort of bias. For instance, the present invention provides more clarity even for the organizational, specific context-based jargon which an uninitiated person may struggle to follow or not understand. In an example, Participant 1 during the meeting mentioned that “The Concerned IP has been blacklisted”. The present invention uses the machine learning based trained model to detect unconscious bias words used in the sentences by the participants and display a notification to the Participant 1 on using the word “blacklisted” in the sentence. In addition, the present invention also recommends a replacement of the bias term to the Participant. For instance, the present invention may suggest Participant 1 to use “The Concerned IP has not been safelisted” instead of using “The Concerned IP has been blacklisted” in future.

In an embodiment of the present disclosure, the participants in the meeting are assisted by first receiving, at the processor, audio data associated with the speaker(s) that are participating in the meeting. Next, the method comprises analyzing, by the processor using a trained model, the audio data in real-time to detect the use of jargon used by at least one speaker. Next, the method comprises identifying, collating and providing relevant data associated with the jargon to the participant for ease of reference of the participant during the meeting.

In an example, during the meeting, Participant 1 tells other participants that “you can check it in xyz platform”. The present invention, using the trained model, identifies the relevant data associated with the xyz platform and provides a hyperlink of the source of the xyz platform to the other participants for the ease of reference.

In an embodiment of the present disclosure, the participants in the meeting are assisted by first receiving, at the processor, audio data associated with the participants in the meeting. Next, the method comprises analyzing, by the processor using a trained model, the audio data to detect a pitch of one or more of the participants, text spoken by the participants, and a time duration of a spoken sentence. Next, the method comprises displaying, by the processor via a display, a notification associated with at least one event for which the pitch of one or more of the participants is higher than a predefined threshold level.

In an example, the audio data received from the participants are segmented into various time durations to check the frequency and pitch of each respective participant in that respective time duration. The frequency and pitch of the participants are identified to check the emotion (i.e., favorable or unfavorable) of the participants i.e., assertive, aggressive, non-assertive, and/or non-aggressive. In an example, during the meeting, Participant 2 tells other participants that “I want this project by 5:00 PM”. The present invention, based on the analysis of the audio data of Participant 2, found that during such time period, the frequency of the Participant 2 was above a predefined threshold frequency (such as above 200). Based on the frequency, the present invention displays a notification to the Participant 2 i.e., “[Participant_2[09:10:08 am]: I want this project by 5:00 PM]; You may have appeared over-assertive]”.

In an embodiment of the present disclosure, the participants in the meeting are assisted by first receiving, at the processor, video data associated with the participants in the meeting. Next, the method comprises analyzing, by the processor using a trained model, the video data to detect facial expression(s), gesture(s) and emotion(s) of a particular participant, text spoken by the participant, a time duration of a spoken sentence and the like. Next, the method comprises displaying, by the processor via a display, the notification associated with at least one event for which the emotion of the speaker/participant is detected as being aggressive in the meeting based on the analysis of the video data.

In an example, the video data received from the participants are segmented into various time durations to check the emotion(s) and gesture(s) of each respective participant i.e., assertive, aggressive, non-assertive, and/or non-aggressive. In an example, during the meeting, Participant 2 tells other participants that “I want this project by 5:00 PM”. The present invention, based on the analysis of the video data of Participant 2, found that during such time, Participant 2 had anger emotions. Based on the emotion, the present invention displays a notification to the Participant 2 i.e., “[Participant_2[09:10:08 am]: I want this project by 5:00 PM]; You may have appeared aggressive]”.

In an embodiment of the present disclosure, the notification of emotion is displayed to the participant based on the audio data, video data, and/or combination of analysis of audio and video data.

After assisting the participants of the meeting, the method terminates at step [410].

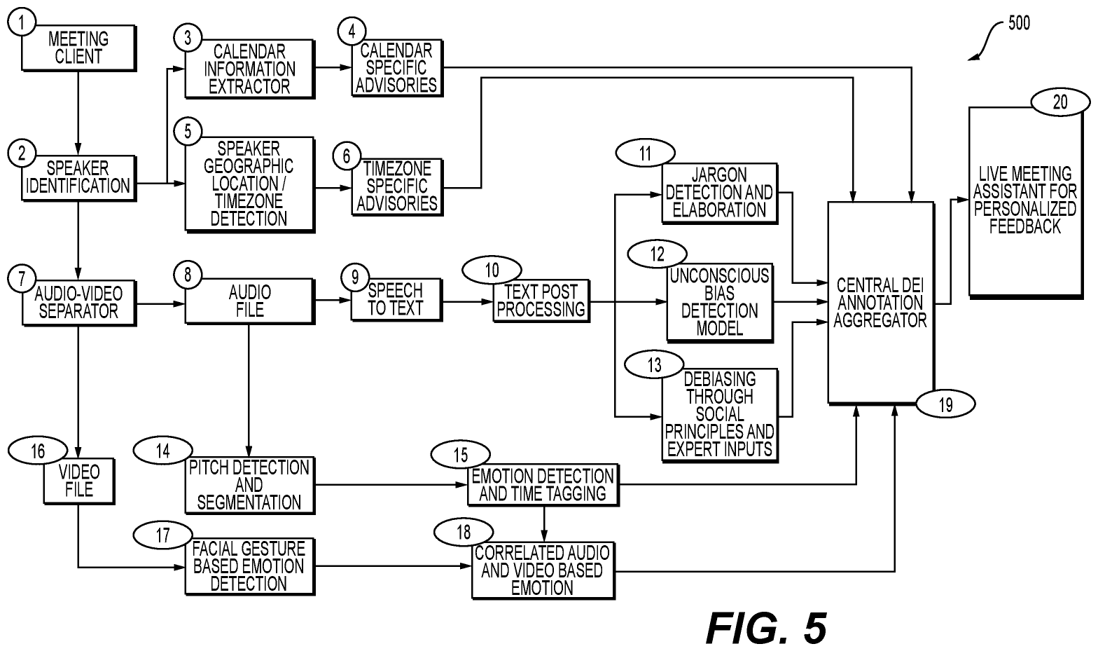

FIG. 5 is a diagram that illustrates a process flow usable for implementing a method for providing a virtual assistant to the participants in a meeting, according to an exemplary embodiment. In an example, at step 1, the meeting started with a client for discussion on a project. Next, at step 2, speakers and/or participants are identified from the meeting. Next, at step 3 and step 4, a calendar information extractor extracts calendar specific advisories based on the identification of the speaker(s). The calendar specific advisories correspond to the advice or suggestions received by the participants based on the extraction of the calendar information and requirement(s) of the participants. In an example, participants often get trouble when the meetings tend to overshoot from schedule. The calendar specific advisories work in background as non-interruptive cues such as silent time check pop up. The virtual meeting assistant considers the calendar information, behavior of the participant in the meeting, urgency of the participants to leave the meeting and the like to provide the calendar specific advisories to the participants in a non-interruptive manner. In an example, the virtual meeting assistant automatically records, transcribes, summarizes the rest of the conversation and delivers it to required participants in case the one or more participants leave the meeting early due to various conditions. In another example, the virtual meeting assistant sends one or more reminders to the participants related to the time left of the meeting so that the participants can conclude their discussion within the meeting time.

Next at step 5 and step 6, geographical locations and time zones of the identified speakers are detected for the time zone specific advisories. Next, at step 7, the audio file and video file of the speaker of the participants are separated for further processing and assistance. At step 8, step 9, and step 10, the audio file (8) is processed to convert the speech into the text format and then the converted text is further processed for the detection of various activities of the speaker/participants. As illustrated in FIG. 5, at step 11, step 12, and step 13, the text is processed for jargon detection and elaboration, for unconscious bias detection using a model, and for performing debiasing thorough social principles and expert inputs. Similarly, at step 14 and step 15, the audio file (8) is processed for pitch detection and segmentation, for emotion detection, and for time tagging. At step 16 and step 17, the video files (16) of the speakers or participants are processed to detect facial gesture-based emotion detection. At step 18, the received audio data and video data are analyzed for correlating audio and video-based emotions. In an example, the correlation between the audio and video data is done to accurately identify the types of emotions. For instance, identification of non-favorable emotion(s) based on the analysis of both the audio data and the video data increases the reliability on the identified emotion(s) and the participants can be accurately provided with feedback on the emotions. After collecting the input data required to provide the assistance to the participants, including but not limited to collected from steps 4, 11, 12, 13, 15 and 18, the present disclosure at step 19 annotates the data via a central Diversity Equity and Inclusion (‘DEI’) annotation aggregator. With respect to the present invention, the DEI annotation aggregator is also referred to as the processor configured to process the input data for providing assistance to the participants. Next, at step 20, the present invention provides a live meeting assistant for personalized feedback to the participants of the meeting based on the analysis and processing of the received input data. The personalized feedback of the meeting is displayed to the participants on the screen of the user equipment associated with the participants of the meeting. In an example, Participant A attends the meeting on the laptop and then the feedback associated with the meeting is displayed to Participant A on the screen of the laptop. In a non-limiting embodiment, the personalized feedback may be displayed to the user using a Display Unit, and the personalized feedback may also be notified to the user using an audio unit such as a speaker.

Accordingly, with this technology, an optimized, efficient and interactive assistant to the participants of the meeting is disclosed. As evident from the above disclosure, the present solution provides a significant technical advancement over the existing solutions by automatically providing an assistant to the participants of the meeting using trained models. Further, the assistant to the participants of the meeting makes the meeting more interactive, efficient and productive. For example, providing a summary of the meeting to the participants of the meeting helps the participants to understand each and every aspect of the discussion at any instant of time during the course of project. In another example, preventing the use of unconscious bias words during the meeting also helps the participants to build good and long relations with other participants in the meeting. Thus, the present invention also promotes diverse, equity and inclusive culture by considering various factors associated with the meeting such as geographical locations of the participants, time zone variations among the participants, detection of unconscious bias words used by the participants, and the like.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

According to an aspect of the present disclosure, a non-transitory computer readable storage medium storing instructions for providing a virtual assistant to the participants in a meeting is disclosed. The instructions include executable code which, when executed by a processor, may cause the processor to receive a set of data associated with the meeting; analyze the set of data using a trained model to provide the virtual assistant to the participants in the meeting; and assist the participants in the meeting based on the analysis of the set of data.

In accordance with an exemplary embodiment, the set of data comprises meeting details, participants details, discussion details, audio details, and video details.

In accordance with an exemplary embodiment, the processor assists the participants in the meeting by receiving audio data associated with a speaker that is participating in the meeting; transcribing the received audio data into raw textual data; processing the raw textual data into processed textual data, wherein the processed textual data comprises a name of the speaker, corresponding text, a start time at which the speaker begins speaking, and an end time at which the speaker stops speaking; and displaying, via a display, the processed textual data based on a requirement of the participants.

In accordance with an exemplary embodiment, the processor assists the participants in the meeting by receiving geographic details and time zone details of the participants; analyzing the geographic details and the time zone details of the participants to determine a variation among the geographic details and the time zone details of the participants in the meeting; and displaying, via a display, a notification that relates to the variation among the geographic details and the time zone details of the participants in the meeting.

In accordance with an exemplary embodiment, the processor assists the participants in the meeting by receiving audio data associated with at least one speaker that is participating in the meeting; analyzing the audio data using a trained model in real-time to detect unconscious bias words used by the at least one speaker; displaying a notification to the at least one speaker that relates to the unconscious bias words; and suggesting a replacement of the unconscious bias words to the at least one speaker.

In accordance with an exemplary embodiment, the processor assists the participants in the meeting by receiving audio and video data associated with the participants in the meeting; analyzing the audio and video data using a trained model to detect a pitch of one of the participants, a gesture of the one of the participants, an emotion of the one of the participants, text spoken by the one of the participants, and a time duration of a spoken sentence; and displaying a notification associated with at least one event for which the pitch of the one of the participants is higher than a predefined threshold level, and/or for which the emotion of the one of the participants is identified as being an unfavorable emotion.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing a virtual assistant to participants in a meeting, the method comprising:
receiving, at a processor, a set of data associated with the meeting;
analyzing, by the processor using a trained model, the set of data to provide the virtual assistant to the participants in the meeting;
assisting, by the processor, the participants in the meeting based on the analysis of the set of data.

2. The method as claimed in claim 1, wherein the set of data comprises meeting details, participant details, discussion details, audio details, and video details.

3. The method as claimed in claim 1, wherein the assisting of the participants in the meeting comprises:
receiving, at the processor, audio data associated with a speaker that is participating in the meeting;
transcribing, by the processor, the received audio data into raw textual data;
processing, by the processor, the raw textual data into processed textual data, wherein the processed textual data comprises a name of the speaker, corresponding text, a start time at which the speaker begins speaking, and an end time at which the speaker stops speaking; and
displaying, by the processor via a display, the processed textual data based on a requirement of the participants.

4. The method as claimed in claim 1, wherein the assisting of the participants in the meeting comprises:
receiving, by the processor, geographic details and time zone details of the participants;
analyzing, by the processor, the geographic details and the time zone details of the participants to determine a variation among the geographic details and the time zone details of the participants in the meeting; and
displaying, by the processor via a display, a notification that relates to the variation among the geographic details and the time zone details of the participants in the meeting.

5. The method as claimed in claim 1, wherein the assisting of the participants in the meeting comprises:
receiving, at the processor, audio data associated with the at least one speaker that is participating in the meeting;
analyzing, by the processor using the trained model, the audio data in real-time to detect unconscious bias words used by the at least one speaker;
displaying, by the processor via a display, a notification to the at least one speaker that relates to the unconscious bias words; and
suggesting, by the processor, a replacement of the unconscious bias words to the at least one speaker.

6. The method as claimed in claim 1, wherein the assisting of the participants in the meeting comprises:
receiving, at the processor, audio data associated with the participants in the meeting;
analyzing, by the processor using the trained model, the audio data to detect a pitch of one of the participants, text spoken by the one of the participants, and a time duration of a spoken sentence; and
displaying, by the processor via a display, a notification associated with at least one event for which the pitch of the one of the participants is higher than a predefined threshold level based on the analysis of the audio data.

7. The method as claimed in claim 1, wherein the assisting of the participants in the meeting comprises:
receiving, at the processor, video data associated with the participants in the meeting;
analyzing, by the processor using the trained model, the video data to detect a gesture and an emotion of one of the participants, text spoken by the one of the participants, and a time duration of a spoken sentence; and
displaying, by the processor via a display, a notification associated with at least one event for which the emotion of the one of the participants is identified as being an unfavorable emotion.

8. A computing device configured to implement an execution of a method for providing a virtual assistant to participants in a meeting, the computing device comprising:
a processor;
a memory; and
a communication interface coupled to each of the processor and the memory, wherein the processor is configured to:
receive, via the communication interface, a set of data associated with the meeting;
analyze a set of data using a trained model to provide the virtual assistant to the participants in the meeting; and
assist the participants in the meeting based on the analysis of the set of data.

9. The computing device as claimed in claim 8, wherein set of data comprises meeting details, participant details, discussion details, audio details, and video details.

10. The computing device as claimed in claim 8, wherein the processor is further configured to assist the participants in the meeting by:
receiving, via the communication interface, audio data associated with a speaker that is participating in the meeting;
transcribing the received audio data into raw textual data;
processing the raw textual data into processed textual data, wherein the processed textual data comprises a name of the speaker, corresponding text, a start time at which the speaker begins speaking, and an end time at which the speaker stops speaking; and
displaying the processed textual data based on a requirement of the participants.

11. The computing device as claimed in claim 8, wherein the processor is further configured to assist the participants in the meeting by:
receiving, via the communication interface, geographic details and time zone details of the participants;
analyzing the geographic details and the time zone details of the participants to determine a variation among the geographic details and time zone details of the participants in the meeting;
displaying a notification that relates to the variation among the geographic details and the time zone details of the participants in the meeting.

12. The computing device as claimed in claim 8, wherein the processor is further configured to assist the participants in the meeting by:
receiving, via the communication interface, audio data associated with at least one speaker that is participating in the meeting;
analyzing the audio data using the trained model in real-time to detect unconscious bias words used by the at least one speaker;
displaying a notification to the at least one speaker that relates to the unconscious bias words; and
suggesting a replacement of the unconscious bias words to the at least one speaker.

13. The computing device as claimed in claim 8, wherein the processor is further configured to assist the participants in the meeting by:
receiving, via the communication interface, audio data associated with the participants in the meeting;
analyzing the audio data using the trained model to detect a pitch of one of the participants, text spoken by the one of the participants, and a time duration of a spoken sentence; and
displaying a notification at least one event for which the pitch of the one of the participants is higher than a predefined threshold level based on the analysis of the audio data.

14. The computing device as claimed in claim 8, wherein the processor is further configured to assist the participants in the meeting by:
receiving, via the communication interface, video data associated with the participants in the meeting;
analyzing the video data to detect a gesture and an emotion of one of the participants, text spoken by the one of the participants, and a time duration of a spoken sentence; and
displaying a notification associated with at least one event for which the emotion of the one of the participants is identified as being an unfavorable emotion.

15. A non-transitory computer readable storage medium storing instructions for providing a virtual assistant to participants in a meeting, the instructions comprising executable code which, when executed by a processor, causes the processor to:
receive a set of data associated with the meeting;
analyze a set of data using a trained model to provide the virtual assistant to the participants in the meeting; and
assist the participants in the meeting based on the analysis of the set of data.

16. The storage medium as claimed in claim 15, wherein the set of data comprises meeting details, participants details, discussion details, audio details, and video details.

17. The storage medium as claimed in claim 15, wherein when executed by the processor, the executable code further causes the processor to assist the participants in the meeting by:
receiving audio data associated with a speaker that is participating in the meeting;
transcribing the received audio data into raw textual data;
processing the raw textual data into processed textual data, wherein the processed textual data comprises a name of the speaker, corresponding text, a start time at which the speaker begins speaking, and an end time at which the speaker stops speaking; and
displaying the processed textual data based on a requirement of the participants.

18. The storage medium as claimed in claim 15, wherein when executed by the processor, the executable code further causes the processor to assist the participants in the meeting by:
receiving geographic details and time zone details of the participants;
analyzing the geographic details and the time zone details of the participants to determine a variation among the geographic details and the time zone details of the participants in the meeting; and
displaying a notification that relates to the variation among the geographic details and the time zone details of the participants in the meeting.

19. The storage medium as claimed in claim 15, wherein when executed by the processor, the executable code further causes the processor to assist the participants in the meeting by:
receiving audio data associated with the at least one speaker that is participating in the meeting;
analyzing the audio data using the trained model in real-time to detect unconscious bias words used by the at least one speaker;
displaying a notification to the at least one speaker that relates to the unconscious bias words; and
suggesting a replacement of the unconscious bias words to the at least one speaker.

20. The storage medium as claimed in claim 15, wherein when executed by the processor, the executable code further causes the processor to assist the participants in the meeting by:
receiving audio and video data associated with the participants in the meeting;
analyzing the audio and video data using the trained model to detect a pitch of one of the participants, a gesture of the one of the participants, an emotion of the one of the participants, text spoken by the one of the participants, and a time duration of a spoken sentence; and
displaying a notification associated with at least one event for which the pitch of the one of the participants is higher than a predefined threshold level.
